(19) United States
(12) Patent Application Publication
(10) Pub. No.: US 2016/0108238 A1
(43) Pub. Date: Apr. 21, 2016

(54) MOLDING METHOD AND MOLDED ARTICLE

(71) Applicant: YAZAKI CORPORATION, Tokyo (JP)

(72) Inventor: Shingo NISHIHARA, Shizuoka (JP)

(73) Assignee: YAZAKI CORPORATION, Tokyo (JP)

(21) Appl. No.: 14/978,500

(22) Filed: Dec. 22, 2015

Related U.S. Application Data
(63) Continuation of application No. PCT/JP2014/066151, filed on Jun. 18, 2014.

(30) Foreign Application Priority Data
Jun. 24, 2013 (JP) 2013-131253

(51) Int. Cl. C08L 81/06; B29C 45/00

(52) U.S. Cl. CPC C08L 81/06; B29C 45/0001; B29K 2081/06

(57) ABSTRACT

Polyether sulfone having a melt viscosity of 65 to 75 Pa·s at a resin temperature of 380° C. and shear velocity of 10000 s⁻¹ is molded at a resin temperature of 350° C. or higher and a temperature of 370° C. or lower. The polyether sulfone being a blend product of polyether sulfones having different viscosities.

### CROSS REFERENCE TO RELATED APPLICATIONS

This application is a Continuation of PCT Application No. PCT/JP2014/066151, filed on Jun. 18, 2014, and claims the priority of Japanese Patent Application No. 2013-131253, filed on Jun. 24, 2013, the content of both of which is incorporated herein by reference.

### BACKGROUND

1. Technical Field

The present invention relates to a molding method and a molded article. In particular, the present invention relates to a molding method and a molded article which use low-viscosity polyether sulfone.

2. Related Art

Conventionally, as shown in FIG. 1, a molded article (resin-molded article) 103 is obtained by using a mold 101. That is, a melted resin is supplied to a core 113 through sprue 107, a runner 109, and a gate 111 from a nozzle 105. After the supply, the resin is cooled to obtain the molded article 103.

Polyether sulfone classified into an amorphous resin has various advantages such as excellent heat resistance and resistance to a severe temperature change.

However, the polyether sulfone does not have a melt viscosity level for allowing injection molding even at temperatures exceeding a glass transition temperature. Therefore, when the polyether sulfone is molded, a resin temperature when the polyether sulfone is molded is usually raised to 350° C. or higher and 380° C. or lower. The temperature of the mold 101 used for molding is usually set to a high level of 100° C. or higher.

Herein, examples of literatures related to the conventional technique include Patent Literatures JP 2003-53767 A and JP 2007-113011 A.

### SUMMARY OF THE INVENTION

As described above, when the polyether sulfone (for example, “ULTRASONE E 1010” manufactured by BASF A.G. (hereinafter, referred to as “E1010”)) is conventionally molded, the temperature of the polyether sulfone such as E1010 is raised. Therefore, a cool time must be lengthened in order to cool the molded article (product) 103 to a temperature at which the molded article (product) 103 can be extracted, which disadvantageously causes the prolongation of a cycle time when the molded article 103 is molded.

The prolongation of the cycle time causes an increase in the cost of the molded article. When the molded article is extracted without sufficiently lowering the temperature of the molded article, defects such as fracture and deformation occur in the molded article.

When the polyether sulfone such as E1010 is molded, and the resin temperature during molding is raised, heat deterioration is caused in the polyether sulfone, which causes an increase in the number of defective products because of black points occurring in the molded article, for example.

When the polyether sulfone such as E1010 is conventionally molded, it is necessary to increase the fill pressure of the incited polyether sulfone according to a high melt viscosity. An insufficient fill pressure is apt to cause molding defects such as short shot. Then, in order to compensate the shortage of the fill pressure, mold design is devised by an increase in the diameter of a sprue or runner, or the like.

However, the increase in the diameter of the sprue or runner causes an increase in the amount of the polyether sulfone with which the sprue or the runner is filled, which disadvantageously causes an increase in a material loss rate.

The present invention has been made in view of the aforementioned problems, and it is an object of the present invention to provide a molding method and molded article of polyether sulfone, in which a cycle time can be shortened while an increase in a material loss rate is suppressed.

A method for molding polyether sulfone according to the present invention, the method including the step of molding the polyether sulfone at a resin temperature of 350° C. or higher and 370° C. or lower, in which the polyether sulfone has a melt viscosity of 65 Pa·s or more and 75 Pa·s or less at a resin temperature of 380° C. and shear velocity of 10000 s⁻¹.

A molded article of polyether sulfone according to the present invention, the polyether sulfone having a melt viscosity of 65 Pa·s or more and 75 Pa·s or less at a resin temperature of 380° C. and shear velocity of 10000 s⁻¹ and molded at a resin temperature of 350° C. or higher and 370° C. or lower.

The present invention can advantageously shorten a cycle time while suppressing an increase in a material loss rate in a molding method and molded article of polyether sulfone.

### BRIEF DESCRIPTION OF DRAWINGS

FIG. 1 schematically illustrates the molding of polyether sulfone according to a conventional technique and an embodiment of the present invention using a mold.

FIG. 2 illustrates the relation between shear velocity and a melt viscosity in polyether sulfone used in a molding d according to the embodiment of the present invention and polyether sulfone used in a conventional molding method.

FIG. 3 illustrates a molding condition of a method for molding polyether sulfone according to the embodiment of the present invention and a molding condition of a conventional method for molding polyether sulfone.

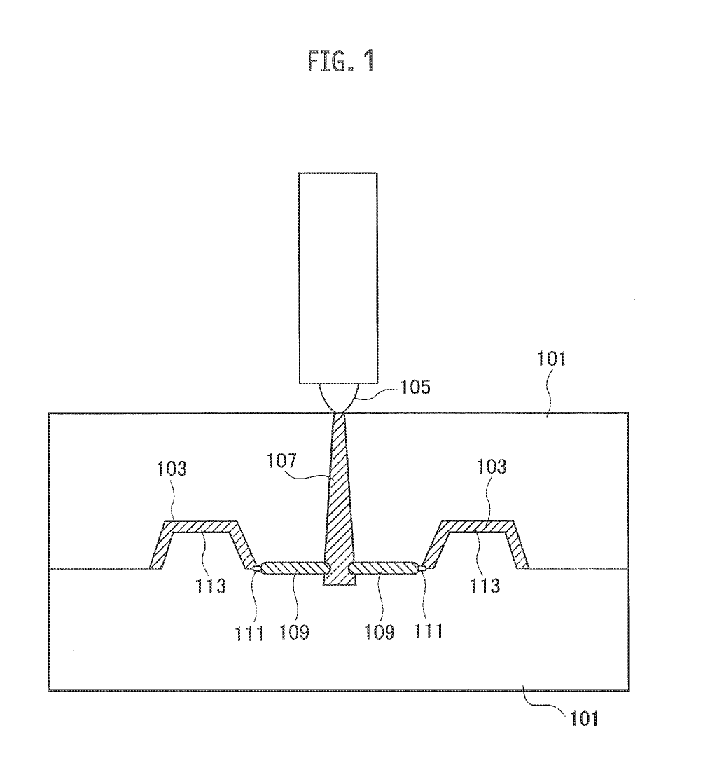

### DETAILED DESCRIPTION

An embodiment of the present invention is described in detail with reference drawings.

In this specification, it must be noted that drawings are schematic views, and constitutions of devices and systems are different from constitutions of an actual device. Accordingly, the specific constitutions should be determined by taking into account the description made hereinafter. Further, it is also needless to say that the respective drawings include portions having different constitutions.

The embodiment of the present invention described hereinafter is provided for exemplifying a device and a method which embody the technical concept of the present invention, and the technical concept of the present invention does not limit materials, shapes, structures, arrangements and the like of the respective constitutional parts to the followings. Various modifications are conceivable with respect to the technical concept of the present invention within the technical scope described in claims.

A molding method according to an embodiment of the present invention also provides a molded article (product) 103 using injection molding using a mold 101, for example, as in a conventional molding method.

However, in order to shorten a cycle time of molding, for example, in the molding method according to the embodiment of the present invention, a blend material of high-viscosity polyether sulfone (for example, E1010) and low-viscosity polyether sulfone (for example, “ULTRASONE 0510 NAT” manufactured by BASF A.G.) is molded at a low temperature. Hereinafter, “ULTRASONE E 0510 NAT” may be referred to as “E0510”.

Polyether sulfones E1010 and E0510 are examples of amorphous thermoplastic resin materials.

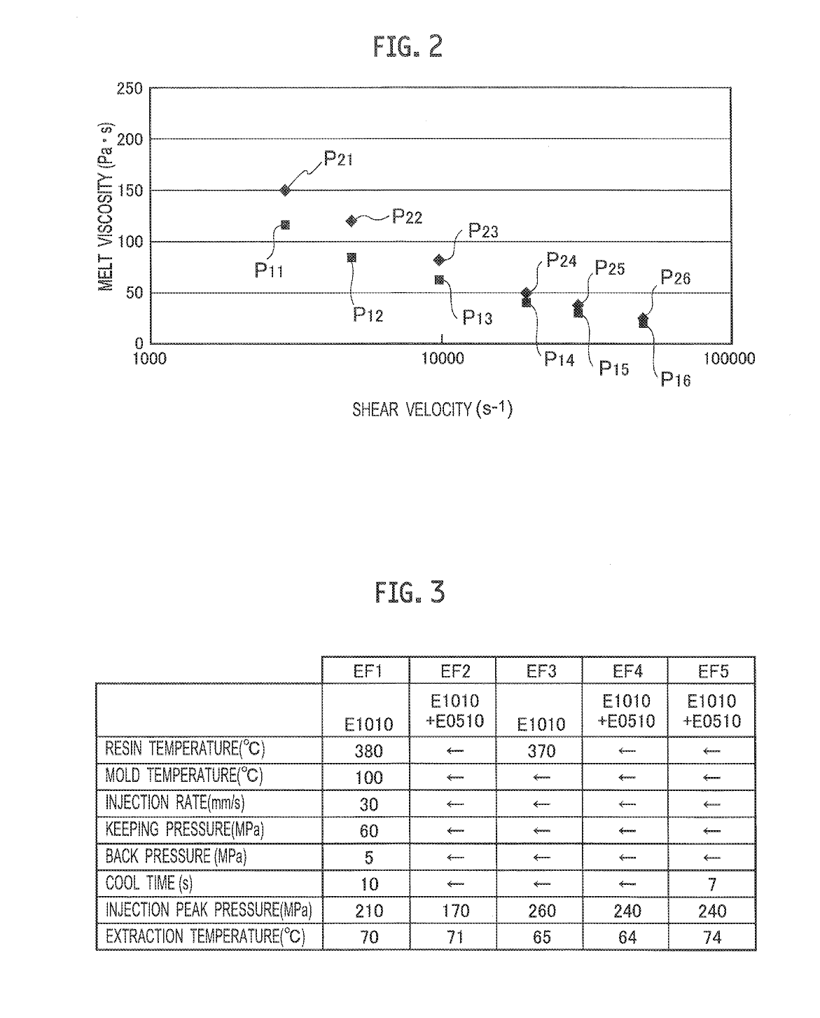

The relation between shear velocity and a melt viscosity in E1010 conventionally used is shown by points P₂₁, P₂₂, P₂₃, P₂₄, P₂₅, and P₂₆ in FIG. 2. On the other hand, the relation between shear velocity and a melt viscosity in a blend material. (E1010+E0510) of E1010 and E0510 used in the molding method of the embodiment of the. present description is shown by points P₁₁, P₁₂, P₁₃, P₁₄, P₁₅, and P₁₆ in FIG. 2.

E1010 used for conventional molding has a melt viscosity of 82 Pa·s at P₂₃ when the shear velocity is 10000 s⁻¹ at 380° C., for example.

On the other hand, the polyether sulfone (E1010+E0510) used in the molding method according to the embodiment of the present invention has a melt viscosity of 65 Pa·s or more and 75 Pa·s or less (the melt viscosity may be 70 Pa·s or more and 75 Pa·s or less) at 380° C. and shear velocity of 10000 s⁻¹, for example. Cracks may occur depending on the structure of the molded article and the structure of the mold when the melt viscosity is 65 Pa·s or more and 75 Pa·or less, which may disable continuous molding. However, when the melt viscosity is 70 Pa·s or more and 75 Pa·s or less, the continuous molding can be performed irrespective of the structure of the molded article and the structure of the mold.

Regarding a weight ratio in E1010+E0510 in the molding method according to the embodiment of the present invention, E1010 is 1, by contrast, E0510 is 0.4 or more and 0.5 or less. A resin temperature during molding of E1010 E0510 is 350° C. or more and 370° C. or less.

FIG. 3 illustrates a molding condition of a conventional molding method and a molding condition of a molding method according to an embodiment of the present invention.

A row EF1 shows an example of the conventional molding method using E1010. A row EF2 shows an example of the molding method according to the embodiment of the present invention using one in which a weight ratio in E1010+E0510 is E101.0:E0510=6:4. A row EF3 shows an example of the conventional molding method using E1010. A row EF4 shows an example of the molding method according to the embodiment of the present invention using one in which a weight ratio in E1010+E0510 is E1010:E0510=6:4. A row EF5 shows an example of the molding method according to the embodiment of the present invention using one in which a weight ratio in E1010+E0510 is E1010:E0510=6:4.

Furthermore, a rectangular plate-like molded article 103 having a size of 127 mm×12.6 mm×1.6 mm is molded by E1010 or E1010+E0510 in each molding shown in FIG. 3.

An arrow in a cell of FIG. 3 means that the numerical value of the cell in which the arrow is described is the same as that of a cell which is at the left of the cell in Which the arrow s described.

The resin temperature of E1010+E0510 is made low (the resin temperature is changed to 370° C. from 380° C.) in examples of EF4 and EF5 to cause an increase in an injection peak pressure (the injection peak pressure is changed to 240 MPa from 170 MPa). However, the injection peak pressure of examples of EF4 and EF5 are kept at a lower level than that of the conventional material (E1010) (260 MPa in E1010).

Even if the cool time is shortened in example of EF5 (even if the cool time is changed to 7 seconds from 10 seconds), the extraction temperature of EF5 is at a level (74° C.) equivalent to that (70° C.) in the conventional cool time (10 seconds).

With reference to the rows EF2, EF4, and EF5 of FIG. 3, in the molding condition of the molding method of E1010+E0510 according to the embodiment of the present invention, the resin temperature of E1010+E0510 is 370° C. or more and less than 380° C., and a mold temperature is about 100° C. Furthermore, an injection rate is about 30 mm/s; a fill pressure (keeping pressure) is about 60 MPa; a back pressure is about 5 MPa; a cool time is 7 seconds or more and less than 10 seconds e preferably, 7 seconds); and an injection peak pressure is about 170 MPa to about 260 MPa. The extraction temperature of the molded article molded under the molding condition is 64° C. or more and 74° C. or less. In particular, when the cool time is 7 seconds, the extraction temperature is 74° C.

As the molding condition of E1010+E0510 according to the embodiment of the present invention, the molding condition shown in the row EF5 sufficiently shortens the cycle time.

When the molding condition of E1010+E0510 which is an example of polyether sulfone according to the embodiment of the present invention departs from the above range, various defects occur. For example, when the melt viscosity is too low, the injection peak pressure is decreased, which may cause fracture and cracks. When the melt viscosity is too high, the injection peak pressure is increased, which provides a low molding effect, and thereby the temperature cannot be lowered.

According to the method for molding polyether sulfone according to the embodiment of the present invention, the mixture ratio and molding condition of the low-viscosity polyether sulfone (E0510) and high-viscosity polyether sulfone (E1010) are devised, and thereby the cool time for cooling the molded article 103 to a temperature at which the molded article 103 can be extracted can be shortened, which can shorten the cycle time when the molded article 103 is molded. The increase in the cost of the molded article 103 can be suppressed by shortening the cycle time. The molded article 103 can be extracted after the temperature is sufficiently lowered, which prevents defects such as fracture and deformation from occurring in the molded article 103.

When the blend material of the low-viscosity polyether sulfone and high-viscosity polyether sulfone is molded, the resin temperature when the polyether sulfone is molded is made lower than before. Thereby, the heat deterioration of the polyether sulfone is suppressed, which suppresses defects such as black points occurring in the molded article 103.

Since the blend material is molded at a low temperature according to the method for molding the blend material of the low-viscosity polyether sulfone and high-viscosity polyether sulfone according to the embodiment of the present invention, the shortage of the fill pressure does not occur even if the diameter of a sprue 107 or runner 109 is not increased. Therefore, the amount of the polyether sulfone with which the sprue 107 or the runner 109 is filled can be lessened, which can suppress an increase in a material. loss rate.

According to the method for molding the blend material of the low-viscosity polyether sulfone and high-viscosity polyether sulfone according to the embodiment of the present invention, the injection peak pressure can be made lower than the conventional case, and the molding condition is wider than before, which provides easy management. Furthermore, a molding pressure is reduced, which can reduce the size of a molding machine used for molding.

Although the embodiment of the present invention has been described heretofore, the embodiment is merely exemplified for facilitating the understanding of the present invention, and the present invention is not limited to the embodiment. The technical scope of the present invention may include not only the specific technical matters disclosed in the above-described embodiment but also various modifications, changes, and alternative techniques easily derived from the above-described specific technical matters.

What is claimed is:

1. A method for molding polyether sulfone, the polyether sulfone being a blend product of polyether sulfones having different viscosities,
the method comprising the step of molding the blend product at a resin temperature of 350° C. or higher and 370° C. or lower, wherein the blend product has a melt viscosity of 65 Pa·s or more and 75 Pa·s or less at a resin temperature of 380° C. and shear velocity of 10000 s⁻¹.

2. A molded article of polyether sulfone, the polyether sulfone being a blend product of polyether sulfones having different viscosities,
the blend product being molded at a resin temperature of 350° C. or higher and 370° C. or lower,
wherein
the blend product has a melt viscosity of 65 Pa·s or more and 75 Pa·s or less at a resin temperature of 380° C. and shear velocity of 10000 s⁻¹, and
a weight ratio of low-viscosity polyether sulfone blended in the blend product is 28.6% or more and 40% or less.
